(19) United States
(12) Patent Application Publication
(10) Pub. No.: US 2011/0180676 A1
(43) Pub. Date: Jul. 28, 2011

(54) CLIPPING STRUCTURE FOR WRITING INSTRUMENT

(75) Inventor: Masahiro Yasunaga, Osaka-shi (JP)

(73) Assignee: SAKURA COLOR PRODUCTS CORPORATION, Osaka-shi (JP)

(21) Appl. No.: 12/673,825

(22) PCT Filed: Aug. 20, 2008
(86) PCT No.: PCT/JP2008/064785

§ 371 Date: Feb. 17, 2010

(30) Foreign Application Priority Data
Aug. 21, 2007 (JP) 2007-214786

(51) Int. Cl. F16B 2/20

(52) U.S. Cl. 248/231.81

(57) ABSTRACT

A clipping structure includes a main body, a clip member, and an urging member for urging the clip member. The main body has a connecting protrusion, whereas the clip member has two lateral parts, between which the connecting protrusion is arranged. Further, the connecting protrusion has receptacles on its outer surfaces, whereas the lateral parts have shaft projections on its inner surfaces respectively. Fitting of the shaft projections into the respective receptacles connects the clipping member swingably to the main body. The connecting protrusion, where the receptacles are formed, has tapered portions formed on its outer surfaces respectively. Gradual opening of a gap between the lateral parts with distal ends of the shaft projections brought into contact with the respective tapered portions fits the shaft projections in the respective receptacles.

### BACKGROUND OF THE INVENTION

1. Field of the Invention

The present invention relates to a clipping structure for a writing instrument.

2. Background Art

Conventionally, some writing instruments such as a ball-point pen are provided with a clipping structure, which is used by clipping cloth of a pocket between the clipping structure and a main body of the instrument.

Such a clipping structure includes a configuration in which the clipping structure is movably urged to the main body.

A patent document 1 specified below discloses a clipping structure having a clip member with a protrusion and a tubular body with a pivot portion and being urged by a U-shaped tucking spring with the protrusion arranged on the pivot portion.

Further, a patent document 2 specified below discloses a clipping structure for a writing instrument having a configuration in which a main body of a clip member has two side walls, on each of which a receiving hole is formed, while a main body of a ball-point pen has a protrusion with two cylindrical projections or shafts extending from both sides of the protrusion. This clipping structure arranges the shafts on the receiving holes respectively so that the shafts are swingably connected into the holes and are urged by a flat spring.

Patent Document 1: JP 3175933 B

Patent Document 2: JP 2007-130891 A

### SUMMARY OF THE INVENTION

### Problem to be Solved by the Invention

Though there is no disclosure of a specific assembly method in the configuration of the clipping structure in the patent document 2, elastic deformation is generally used to thrust the shafts in the holes so as to arrange the cylindrical projections or shafts in the receiving holes.

Prolonging of the cylindrical projections in order to prevent the shafts from disengagement from the holes would result in difficulty in thrusting of the shafts in the holes. That would also result in difficulty in connection of the shafts into the holes and thus would make an assembly harder. As the case may be, the shafts might not be connected into the holes, or the shafts or the holes might be broken in connection of those.

The present invention therefore aims to provide an improved clipping structure for a writing instrument being easy-to-assembly and having an increased strength during use.

### Means to Solve the Problem

An aspect of the present invention provided herein as described in claim 1 and for achieving the object described above is a clipping structure for a writing instrument including a main body of an elongated shape, a clip member connected to the main body, and an urging member for urging the clip member, wherein one selected from a first group consisting of the main body and the clip member has a connecting protrusion and the other selected from the first group has two lateral parts so that the connecting protrusion is arranged between the two lateral parts, the connecting protrusion having a pair of outer surfaces, the lateral parts having inner surfaces opposed to the outer surfaces respectively, wherein one selected from a second group consisting of at least one of the outer surfaces and at least one of the inner surfaces has a shaft projection (i.e., a projection serving as a shaft) and the other selected from the second group has a receptacle so that the clip member is swingably connected to the main body with the shaft projection fitted in the receptacle, the other selected from the second group and having the receptacle further having a tapered portion, and wherein the clip member is movable in a longitudinal direction of the main body so that the shaft projection is fitted in the receptacle by bringing of a distal end of the shaft projection into contact with the tapered portion and gradually opening a gap between the lateral parts, so that the main body and the clip member are connected to each other.

According to the aspect as described in claim 1, the clip member is swingably connected to the main body by fitting the shaft projection(s) in the receptacle(s). In order to connect the main body and the clip member, the clip member is moved in a longitudinal direction of the main body with the distal end of the shaft projection(s) brought into contact with the tapered portion(s), which gradually opens the gap between the lateral parts, so that the shaft projection(s) are fitted in the receptacle(s). That facilitates connection of the main body and the clip member with protecting those from being broken during the connection of those and ensures the connection of those.

Another aspect of the present invention as described in claim 2 is the clipping structure as described in claim 1, in which the distal end of the shaft projection has a tapered portion, whose inclination is in conformity with the tapered portion formed on the other selected from the second group.

According to the aspect as described in claim 2, the connection of the main body and the clip member is smoothly done because the distal end of the shaft projection has a tapered portion, whose inclination is in conformity with the tapered portion formed in the other selected from the second group.

The urging member may consist of one selected from a flat spring and a coil spring. (claim 3)

### ADVANTAGEOUS EFFECT OF THE INVENTION

The clipping structure for a writing instrument of the present invention allows the main body and the clip member to be protected from being broken in connection of those and easily assembled, thereby ensuring the connection of the main body and the clip member.

### BRIEF DESCRIPTION OF THE DRAWINGS

FIG. 1 is a perspective view of a clipping structure for a writing instrument in a first embodiment of the present invention;

FIG. 2 is an exploded perspective view of the clipping structure shown in FIG. 1;

FIG. 3 is a cross section taken along a line A-A of the clipping structure shown in FIG. 1;

FIG. 4 is a cross section taken along a line B-B of the clipping structure shown in FIG. 1;

FIG. 5 is a front view of the clipping structure shown in FIG. 1 in assembling;

FIG. 6 is a perspective view of a clipping structure for a writing instrument in a second embodiment of the present invention;

FIG. 7 is a cross section showing a connection of the clipping structure to shown in FIG. 6;

FIG. 8 is a perspective view of a clipping structure for a writing instrument in a third embodiment of the present invention;

FIG. 9 is a cross section showing a connection of the clipping structure shown in FIG. 8;

FIG. 10 is a perspective view of a clipping structure for a writing instrument in a fourth embodiment of the present invention; and

FIG. 11 is a cross section showing a connection of the clipping structure shown in FIG. 10.

### DESCRIPTION OF PREFERRED EMBODIMENTS

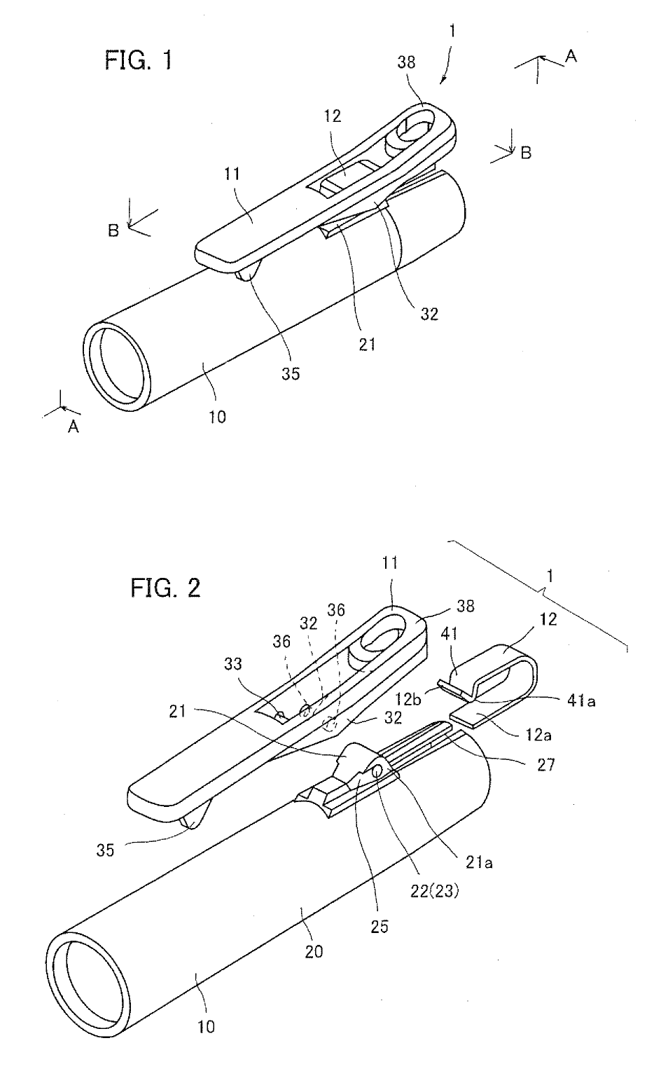

Referring to FIG. 1, a clipping structure 1 for a writing instrument in a first embodiment of the present invention mainly consists of a main body 10, a clip member 11, and an urging member 12. The clip member 11 is swingably connected to the main body 10. The clip member 11 has a holding part 35 urged toward the main body 10 by the urging member 12. The clipping structure 1 is used by clipping a pocket of clothes between the holding part 35 and the main body 10.

As shown in FIG. 2, the main body 10 is of an elongated cylindrical shape with a predetermined length. The main body 10 is constituted by a cylinder 20 and a connecting protrusion 21.

The clipping structure 1 is used with a writing member (not shown) arranged within the cylinder 20 of the main body 10, the writing member writing down on a writing object.

The connecting protrusion 21 protrudes from a surface of the cylinder 20 and is for being connected to lateral parts 32 described below of the clip member 21.

The protrusion 21 has a through-hole 22 formed to penetrate through side faces 21a of the protrusion 21. Both ends of the through-hole 22 are to is be receptacles 23, in which two shaft projections (i.e., projections serving as shafts) 36 are fitted respectively, so that the main body 10 and the clip member 11 are connected to each other.

The connecting protrusion 21 is of a mound-like shape having a length in a longitudinal direction of the main body 10 getting shorter with increasing distance from the cylinder 20. The protrusion 21 may be of a shape other than a mound-like shape.

The through-hole 22 penetrates in a direction perpendicular to the longitudinal direction of the main body 10 and oriented to an axial direction of swinging of the clip member 11.

Herein, as long as the shaft projections 36 can be fitted in the receptacles 23, the receptacles 23 do not necessarily penetrate through the both ends like the through-hole 22 and may be formed in concave portions on the side faces 21a of the protrusion 21.

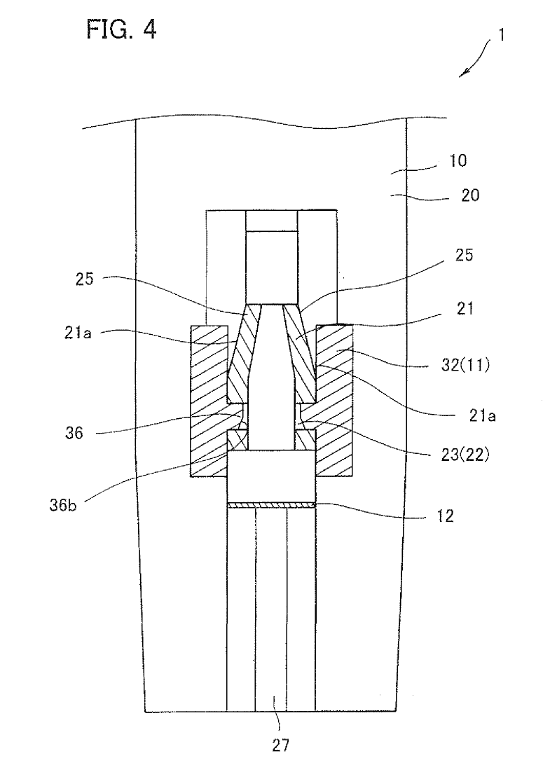

As shown in FIGS. 2 and 4, the connecting protrusion 21 has two tapered portions 25. The tapered portions 25 are respectively formed on the side faces 21a, which are outer surfaces of the protrusion 21, and form a width changing in the longitudinal direction of the main body 10. Specifically, the nearer the receptacle 23 and the larger the width, with a smaller width near the holding part 35 of the clip member 11 and a larger width near an operating end 38 (described below).

The tapered portions 25 are used for connection of the main body 10 and the clip member 11, forming the width changing in the longitudinal direction of the main body 10. That ensures a thickness of an outside of the through-hole 22 compared with formation of tapered portions, for example, having a width changing in a direction toward the cylinder 20. Therefore, after the connection of those, the clipping structure 1 has an increased strength when a force acts on the main body 10 and the clip member 11 in a direction away from each other.

Further, the tapered portions 25 are respectively formed on the side faces 21a adjacent to the cylinder 20. That also ensures strength when a force acts on the clip member 11 in a direction away from the main body 10.

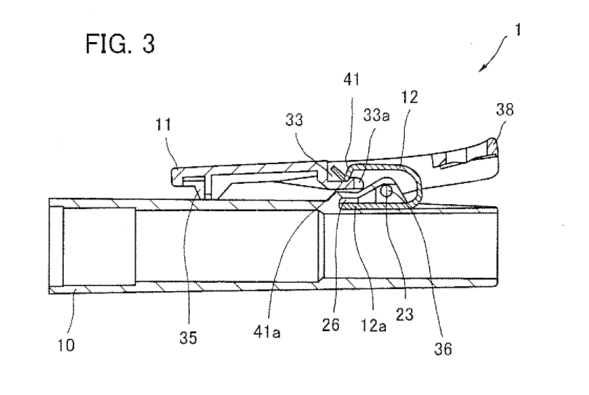

The main body 10, as shown in FIG. 3, has a spring insertion hole 26, which is located adjacent to a base of the connecting protrusion 21. The spring insertion hole 26 is elongated in the longitudinal direction of the main body 10. An end 12a of the urging member 12 is inserted in the hole 26.

Further, the cylinder 20 has a slot 27 extending in the longitudinal direction of the main body 10. However, the slot may be eliminated.

The clip member 11 is, as shown in FIG. 2, an elongated member of a rod-like or a plate-like shape and includes the lateral parts 32, a spring receiving recess 33, and the holding part 35.

As described below, the clip member 11 is urged so that the holding part 35 comes to the cylinder 20 of the main body 10. Holding of the operating end 38 located opposite the holding part 35 performs a clipping operation.

As shown in FIGS. 2 and 4, there are provided the two lateral parts 32, each of which has a plate-like shape extending toward the main body 10. The connecting protrusion 21 is arranged between the lateral parts 32, so that the main body 10 and the clip member 11 are connected to each other.

Further, the shaft projections 36 are formed on inner surfaces of the lateral parts 32, respectively. Each of the shaft projections 36 has a circular cross-sectional shape and extends inwardly to be fitted in the respective receptacle 23. The two shaft projections 36, which are formed on the lateral parts 32 respectively, are coaxially arranged.

As shown in FIG. 4, the shaft projections 36 each have a tapered portion 36b at its distal face. Each of the tapered portions 36b is formed in conformity with the tapered portion 25 of the main body 10 and inclined at substantially the same angle and in the same direction as the tapered portion 25.

The spring receiving recess 33 is formed between the lateral parts 32 and on a surface opposite an extending direction of the lateral parts 32. A V-shaped bend 41 of the urging member 12 is arranged in the spring receiving part 33, so as to urge the clip member 11.

The clip member 11 swings relative to the main body 10 around the shaft projections 36 and the receptacles 23 as a swinging axis. As shown in FIG. 3, the recess 33 is located nearer the holding part 35 and opposite the operating end 38 in relation to the shaft projections 36 and the receptacles 23, so that the clip member 11 is urged so as to move the holding part 35 toward the main body 10.

The main body 10 and the clip member 11 may be made of any material, not being particularly limited, but are resin molding in this embodiment.

The urging member 12, as shown in FIG. 2, consists of a U-shaped flat spring made of metal having a substantially constant width. The urging member 12 is flat at the end 12a and has the V-shaped bend 41 formed at another end 12b. The bend 41 is bent so as to form an apex 41a at inside the U-shape.

As shown in FIG. 3, the end 12a of the urging member 12 is inserted in the spring insertion hole 26, while the bend 41 of the other end 12b is arranged in the spring receiving recess 33 so that the urging member 12 urges the clip member 11 nearer the holding part 35 toward the main body 10.

Next, a method of assembling the clipping structure 1 will be described in detail below.

The clipping structure 1 is assembled by connecting the main body 10 and the clip member 11 to each other and attaching the urging member 12 to those.

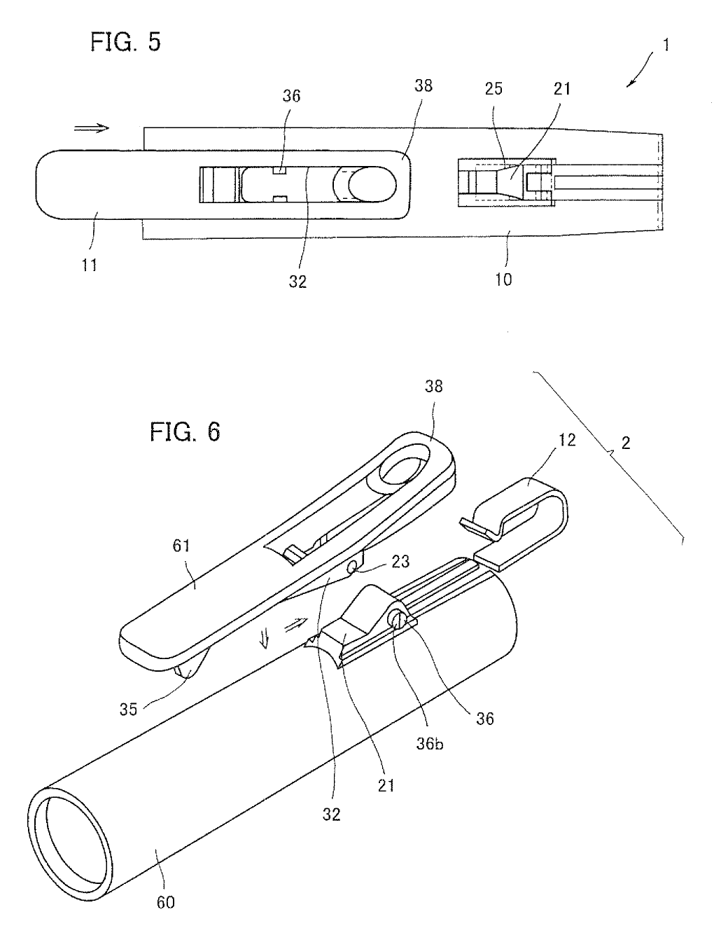

The main body 10 and the clip member 11 are connected to each other as shown in an arrow in FIG. 5. Specifically, the clip member 11 is moved in a direction from a side near the holding part 35 to a side near the operating end 38 of the clip member 11, i.e., in the longitudinal direction of the main body 10 along a surface of the main body 10, so that the lateral parts 32 are moved closer to the connecting protrusion 21 of the main body 10. Then, the connecting protrusion 21 is slid into between the two lateral parts 32. At this time, the distal faces of the shaft projections 36 are respectively brought into contact with the tapered portions 25, whereby a gap between the lateral is parts 32 is gradually opened because of elastic deformation.

Further movement of the clip member 11 allows the shaft projections 36 to be fitted in the respective receptacles 23, thereby completing the connection of the main body 10 and the clip member 11, rendering a state as shown in FIG. 4. Upon connection, the lateral parts 32 whose gap has been opened because of elastic deformation return to the first state.

After the connection of the main body 10 and the clip member 11, the shaft projections 36 are difficult to disengage from the receptacles 23, being not disconnected from each other. The clip member 11 is swingable around the shaft projections 36 as a swinging axis.

Further, the urging member 12 is attached by inserting the end 12a into the spring insertion hole 26 of the main body 10 with the V-shaped bend 41 of the other end 12b arranged in the spring receiving recess 33.

The attachment of the urging member 12 can be done after the connection of the main body 10 and the clip member 11, or can be done while the connection of the main body 10 and the clip member 11 is being done.

After the attachment of the urging member 12, the end 12a and the V-shaped bend 41 are away from each other as compared to a natural state, and whereby the bend 41 presses the spring receiving recess 33 to urge the clip member 11, with the holding part 35 having contact with the cylinder 20.

Further, as shown in FIG. 3, the apex 41a of the bend 41 gets hung up on a protruding part 33a of the spring receiving recess 33 near the operating end 38. That avoids disengagement of the urging member 12.

A clip part of the clipping structure 1 is used by holding the operating end 38 and the cylinder 20 to open the clip member 11 near the holding part 35 and clipping something at this state. The thing having been clipped is moved to be separated from the clip part by holding the operating end 38 and the cylinder 20 again, and then writing is done.

The clipping structure 1 in the above-mentioned embodiment has the receptacles 23 formed on the respective outer surfaces of the connecting protrusion 21 and the shaft projections 36 formed on the respective inner surfaces of the lateral parts 32. However, the inverse structure can be employed. Specifically, the shaft projections 36 are formed on the outer surfaces of the connecting protrusion 21 and the receptacles 23 are formed on the inner surfaces of the lateral parts 32, respectively. In this case, the tapered portions 25 are formed on the inner surfaces of the lateral parts 32 where the receptacles 23 are formed.

Further, the clip member 11 may be moved in a direction opposite to the moving direction of the clip member 11 employed for the clipping structure 1 in the above-mentioned embodiment when the main body 10 and the clip member 11 are connected to each other. Specifically, each of the tapered portions 25 may be arranged so as to have a larger width near the holding part 35 of the clip member 11 and a smaller width near the operating end 38 thereof. In this case, the clip member 11 is moved closer to the connecting protrusion 21 of the main body 10 from a side near the holding part 35 of the clip member 11 along the surface of the main body 10, so that the main body 10 and the clip member 11 are connected to each other.

Further, the urging member 12 consists of a flat spring, but may consist of another one such as a coil spring.

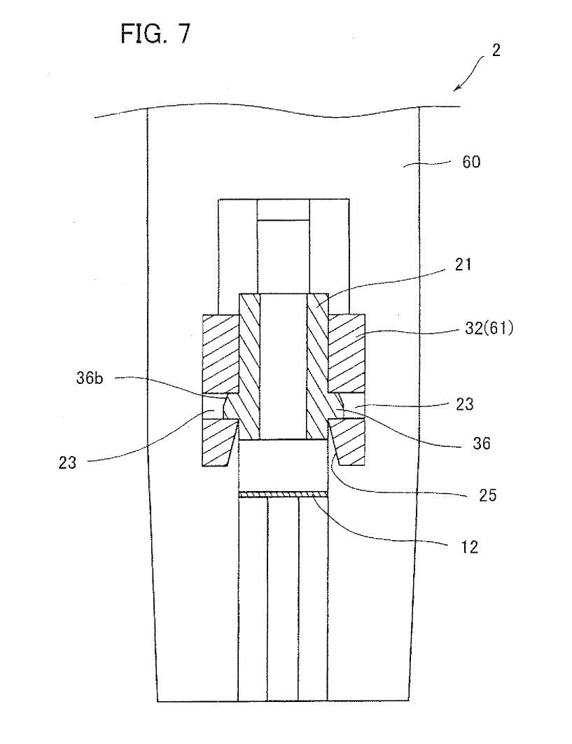

A clipping structure 2 for a writing instrument in a second embodiment of the present invention, as shown in FIGS. 6 and 7, includes a main body 60, a clip member 61, and the urging member 12. The clip member 61 has the lateral parts 32, on which the receptacles 23 are formed respectively. The main body 6o has the connecting protrusion 21 provided with the shaft projections 36 respectively.

As shown in FIG. 7, the tapered portions 25 are formed on the inner surfaces of the lateral parts 32 respectively, while the tapered portions 36b are formed at the distal surfaces of the shaft projections 36 of the connecting protrusion 21. As shown by an arrow in FIG. 6, the clip member 61 is moved in a direction from a side near the holding part 35 to a side near the operating end 38 of the clip member 61 along a surface of the main body 60, so that the lateral parts 32 are moved closer to the connecting protrusion 21 of the main body 60. Then, the connecting protrusion 21 is slid into between the two lateral parts 32. The shaft projections 36 of the connecting protrusion 21 are fitted in the respective receptacles 23 of the lateral parts 32 respectively, and whereby the connection of the main body 60 and the clip member 61 is completed.

The urging member 12 and other configurations than the main body 60 and the clip member 61 of the clipping structure 2 are the same as those of the clipping structure 1 described above.

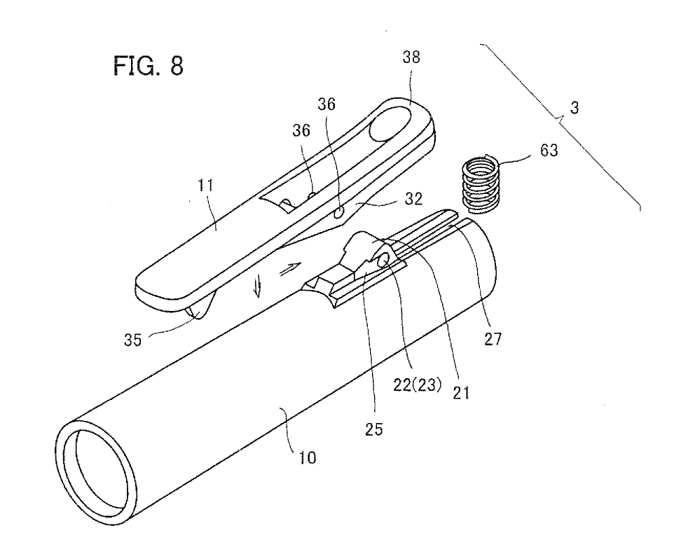

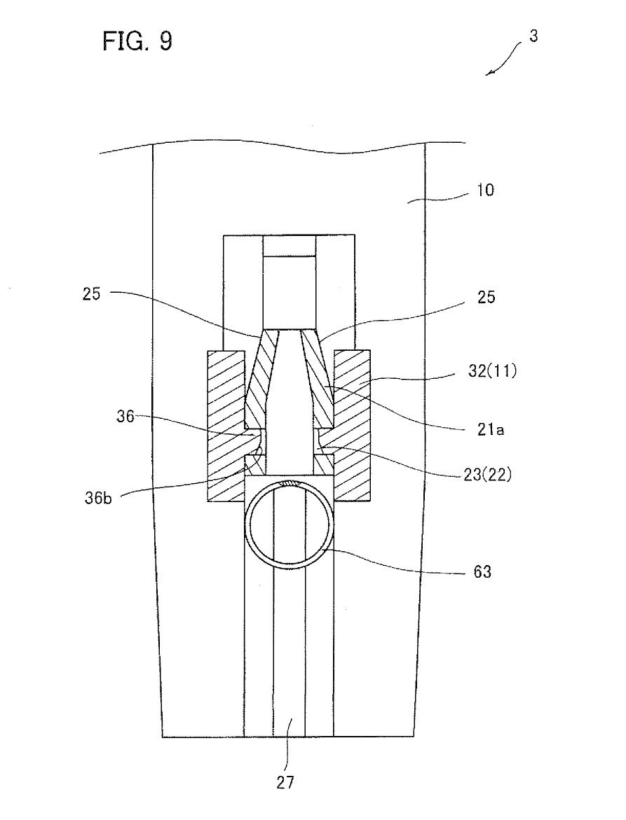

Further, a clipping structure 3 for a writing instrument in a third embodiment of the present invention, as shown in FIGS. 8 and 9, includes the main body 10, the clip member 11, and an urging member 63. Only the urging member 63 is different from that in the clipping structure 1 in the above-mentioned first embodiment. The urging member 63 in this embodiment consists of a coil spring.

The urging member 63 is located adjacent to the operating end 38 of the clip member 11 and between the main body 10 and the clip member 11. The urging member 63 is compressed when being arranged, thereby bringing the holding part 35 into contact with the main body 10.

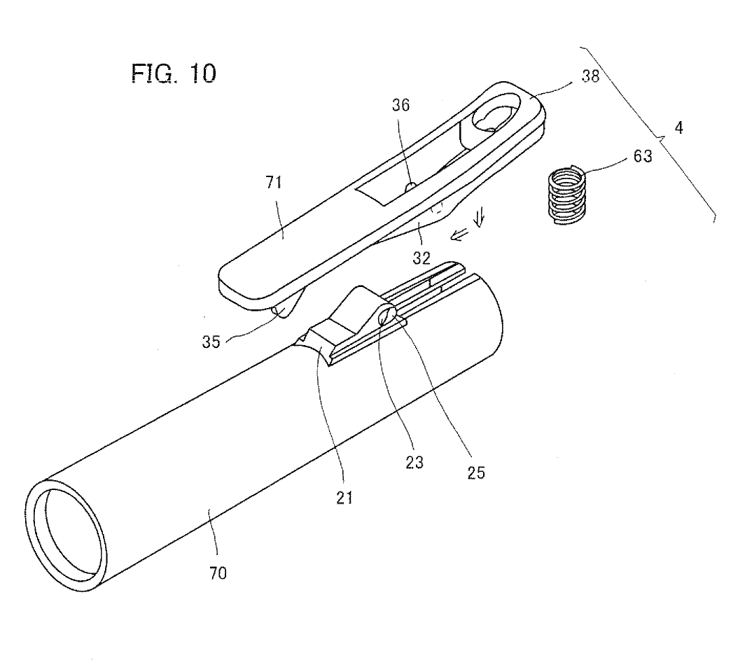

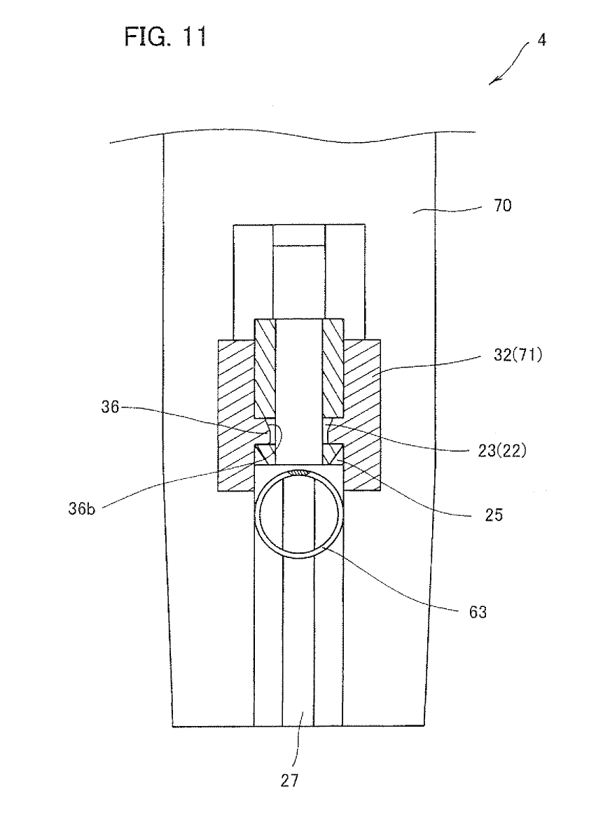

Further, a clipping structure 4 for a writing instrument in a fourth embodiment of the present invention, as shown in FIGS. 10 and 11, includes a main body 70, a clip member 71, and the urging member 63. The clipping structure 4 has the tapered portions 25 and the tapered portions 36b, which are located at positions different from those of the clipping structure 3 in the above-mentioned third embodiment.

Specifically, the tapered portions 25 in this embodiment each have a smaller width nearer the operating end 38 of the clip member 71 and a larger width nearer the holding part 35. The tapered portions 36b, which are the distal faces of the shaft projections 36, are formed in conformity with the tapered portions 25 respectively.

As shown by an arrow in FIG. 10, the clip member 71 is moved in a direction from a side near the operating end 38 of the clip member 71 to a is side near the holding part 35 along a surface of the main body 70, so that the lateral parts 32 are moved closer to the connecting protrusion 21 of the main body 70. Then, the connecting protrusion 21 is slid into between the two lateral parts 32. The shaft projections 36 of the lateral parts 32 are fitted in the respective receptacles 23 of the connecting protrusion 21, and whereby the connection of the main body 70 and the clip member 71 is completed.

1. A clipping structure for a writing instrument comprising:
a main body of an elongated shape;
a clip member connected to the main body; and
an urging member for urging the clip member,
wherein one selected from a first group consisting of the main body and the clip member has a connecting protrusion and the other selected from the first group has two lateral parts so that the connecting protrusion is arranged between the two lateral parts,
the connecting protrusion having a pair of outer surfaces,
the lateral parts having inner surfaces opposed to the outer surfaces respectively,
wherein one selected from a second group consisting of at least one of is the outer surfaces and at least one of the inner surfaces has a shaft projection and the other selected from the second group has a receptacle so that the clip member is swingably connected to the main body with the shaft projection fitted in the receptacle,
the other selected from the second group and having the receptacle further having a tapered portion, and
wherein the clip member is movable in a longitudinal direction of the main body so that the shaft projection is fitted in the receptacle by bringing of a distal end of the shaft projection into contact with the tapered portion and gradually opening a gap between the lateral parts, so that the main body and the clip member are connected to each other.

2. The clipping structure as defined in claim 1,
wherein the distal end of the shaft projection has a tapered portion, whose inclination is in conformity with the tapered portion formed on the other selected from the second group.

3. The clipping structure as defined in claim 1,
wherein the urging member consists of one selected from a flat spring and a coil spring.
